(19) United States
(12) Patent Application Publication
(10) Pub. No.: US 2009/0007715 A1
(43) Pub. Date: Jan. 8, 2009

(54) Qwik throttle repair

(76) Inventor: Terynce Millard Guthrie, Racine, WI (US)

Correspondence Address: Terynce Millard Guthrie, 2512 Coolidge Ave., Racine, WI, 53403, US

(21) Appl. No.: 12/080,563

(22) Filed: Apr. 4, 2008

Related U.S. Application Data
(60) Provisional application No. 60/937,299, filed on Jun. 27, 2007.

(51) Int. Cl. F16C 1/12

(52) U.S. Cl. 74/501.6

(57) ABSTRACT

Consequently, since the present invention is constructed as has been described, even when the rider rotates the handlebar to the left or right, the operation can follow the movements of the fingers and automatically oscillate vertically, thereby making it possible to provide a throttle device that exhibits good operability and which is markedly easy to use when compared with conventional throttle devices.

### FIELD OF THE INVENTION

The device will be connected to the en of the broken cable and then wrapped around the throttle allowing use almost as efficient as the original. This will allow the person to get the vehicle off the road.

### CROSS REFERENCE TO RELATED APPLICATIONS

My searches can be crossed referenced with the U.S. Pat. No. 6,393,933.

### BRIEF DESCRIPTION OF DRAWING FIGURES

FIG. 1 is a picture of the clamp used to hold the cable.

FIG. 2 is another view of the clamp showing the Jaws that grip.

FIG. 3 The retaining screw

This is the screw that helps apply pressure for holding the cable and attaching to the flexible strap.

FIG. 4 Flexible Strap

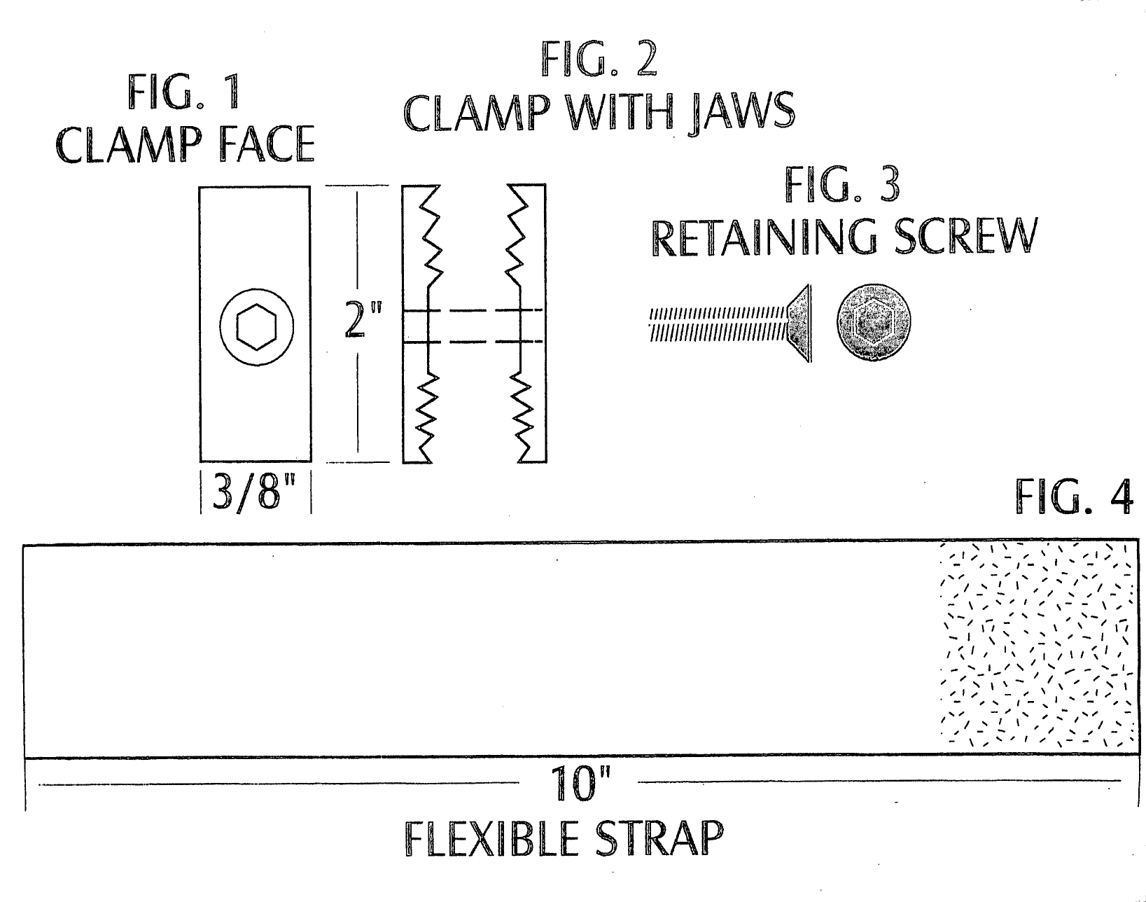

This strap is used for wrapping around the throttle handler to inmate normal throttle response.

1. The above-mentioned invention when used will enable motorcycles, snowmobiles, and any other handle bar mounted throttle cables machinery.

2. Attached to the handlebars, it will save the owner time and towing, allowing him to complete his journey until the next repair point.

3. The said device will be composed of a flexible fabric strap used to wrap around the throttle handle bar.

4. The second piece identifies, as a clamping device will clamp onto flexible strap and then to the broken end of the cable.

5. The third component being the screw that will secure the flexible strap and broken cable together allowing normal throttle operation.
